(19) United States
(12) Patent Application Publication
(10) Pub. No.: US 2013/0226627 A1
(43) Pub. Date: Aug. 29, 2013

(54) MOBILE RESERVATION APPLICATION

(71) Applicants: Sean C. Kubovcik, Lakewood, OH (US); Rob P. Lewandowski, Aurora, OH (US)

(72) Inventors: Sean C. Kubovcik, Lakewood, OH (US); Rob P. Lewandowski, Aurora, OH (US)

(73) Assignee: TA OPERATING LLC, Newton, MA (US)

(21) Appl. No.: 13/404,114

(22) Filed: Feb. 24, 2012

(51) Int. Cl. G06Q 10/02

(52) U.S. Cl. 705/5

(57) ABSTRACT

A method may include receiving, from a user device, a first communication requesting information identifying a site that includes a shower facility and accessing a database storing information associated with a number of sites. The method may also include identifying a site, located within a predetermined distance of the user device, that includes a shower facility, and forwarding, to the user device, a second communication including information identifying the site that includes a shower facility.

### BACKGROUND INFORMATION

Professional drivers, such as truck drivers, often drive for long periods of time. Such drivers are also often on tight schedules. As a result, when a driver stops at a truck stop or travel center, he/she must be able to park, eat and/or shower in a short period of time to avoid getting behind schedule.

### BRIEF DESCRIPTION OF THE DRAWINGS

FIG. 1 illustrates an exemplary network in which systems and methods described herein may be implemented;

FIG. 2 illustrates an exemplary configuration of components implemented in one or more of the devices of FIG. 1;

FIG. 3 illustrates an exemplary configuration of logic components implemented in one of the devices of FIG. 1;

FIG. 4 illustrates an exemplary configuration of logic components implemented in another one of the devices of FIG. 1;

FIG. 5 illustrates an exemplary configuration of logic components implemented in still another one of the devices of FIG. 1;

FIG. 6 is a diagram of an exemplary table stored in the database of FIG. 5;

FIG. 7 is a flow diagram illustrating exemplary processing by various components illustrated in FIG. 1 in accordance with an exemplary implementation;

FIGS. 8A through 8H illustrate information displayed by the user device of FIG. 1 in accordance with an exemplary implementation;

FIG. 9 illustrates additional information displayed by the user device of FIG. 1 in accordance with an exemplary aspect; and

FIG. 10 illustrates additional information displayed by the user device of FIG. 1 in accordance with another exemplary aspect.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein relate to providing a mobile device with the ability to identify services available at one or more sites, such as a travel center or truck stop, for a party traveling in a vehicle. In an exemplary implementation, an application executed by the mobile device allows a user to request information identifying particular services, such as the availability of a shower facility, vehicle repair or maintenance services, parking availability, etc., at a site. The mobile device may transmit the request to a computer or server device that stores information associated with a number of sites and/or communicates with a plurality of systems associated with a number of sites to identify whether a requested service is available at one or more sites located within a predetermined distance of the mobile device.

In some implementations, the computer or server device that receives the request from the mobile device may also provide estimated wait times for the requested service. The user, via the mobile device, may then optionally reserve a particular service or get in a queue for the requested service at one of the sites.

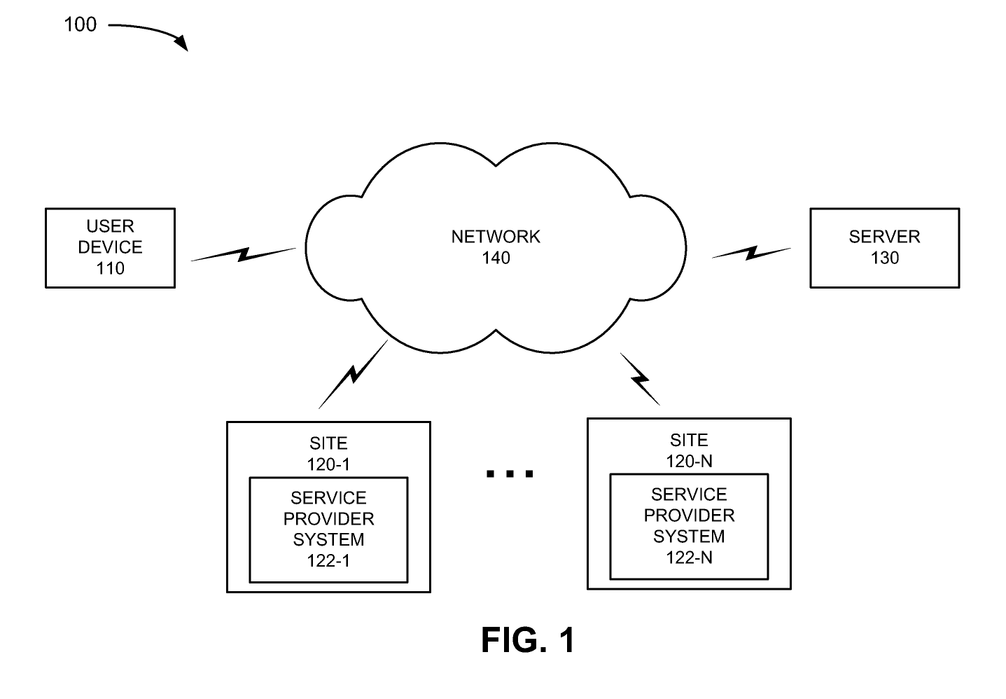

FIG. 1 is a block diagram of an exemplary network 100 in which systems and methods described herein may be implemented. Network 100 may include user device 110, sites 120-1 through 120-N (referred to individually as site 120 or 120-X, or collectively as sites 120), server 130 and network 140. Each of sites 120 may include a corresponding service provider system 122 (referred to individually as service provider system 122 or 122-X, or collectively as service provider systems 122).

User device 110 may include a mobile device, such as wireless or cellular telephone device (e.g., a conventional cell phone with data processing capabilities), a smart phone, a personal digital assistant (PDA) that can include a radiotelephone, etc. User device 110 may also include any type of mobile computer device or system, such as a personal computer (PC), a laptop computer, a tablet computer, a notebook, a netbook, etc., that includes communication functionality.

User device 110 may connect to network 140 and other devices in network 100 (e.g., service provider systems 122, server 130) via any conventional technique, such as wired, wireless, or optical connections. User device 110 and the person associated with user device 110 (e.g., the party holding or interacting with user device 110) may be referred to collectively as user device 110 in the description below. In an exemplary implementation, user device 110 may be used to identify available services from a merchant or vendor at a commercial location, such as one or more of sites 120. For example, user device 110 may interact with server 130 to identify available parking spaces, available shower facilities, vehicle servicing availability information, available food services, etc., that may be available at one or more of sites 120, as described in more detail below.

Sites 120 may represent a commercial location where goods and/or services are available for purchase, such as a travel center or truck/rest stop where food, fuel, showers, vehicle services, etc., are provided. Each of sites 120 may include a service provider system 122 that includes one or more computing devices. Service provider systems 122 may be used by personnel or may interface with automated monitoring or inventory systems at sites 120 to provide information regarding the current availability of various services at the corresponding site 120, such as shower availability, parking availability, mechanic availability, etc. Service provider systems 122 may communicate the information identifying the current availability associated with various services at sites 120 to server 130.

Server 130 may include one or more computer devices and/or servers responsible for communicating with other devices in network 100. For example, server 130 may receive information from service provider systems 122 identifying availability of various services. Server 130 may update a database associated with the service provider systems 122. The database may act as a central repository of data and may be updated in real time or near real time.

Server 130 may also receive requests from user device 110 and provide information to user device 110 in response to the request. As one example, server 130 may provide information identifying available shower facilities at one or more of sites 120, as well as estimated wait times for the shower facilities, as described in detail below.

Network 140 may include one or more wired, wireless and/or optical networks that are capable of receiving and transmitting data, voice and/or video signals. For example, network 140 may include one or more public switched telephone networks (PSTNs) or other type of switched network. Network 140 may also include one or more wireless networks and may include a number of transmission towers for receiving wireless signals and forwarding the wireless signals toward the intended destination. Network 140 may further include one or more satellite networks, one or more packet switched networks, such as an Internet protocol (IP) based network, a local area network (LAN), a wide area network (WAN), a personal area network (PAN), a WiFi network, a Bluetooth network, an intranet, the Internet, or another type of network that is capable of transmitting data.

The exemplary configuration illustrated in FIG. 1 is provided for simplicity. It should be understood that a typical network may include more or fewer devices than illustrated in FIG. 1. For example, network 100 may include a large number (e.g., thousands) of user devices 110, as well as a large number (e.g., hundreds) of service provider systems 122 and multiple servers 130. In addition, network 140 may include additional elements, such as switches, gateways, routers, etc., that aid in routing data. Further, network 100 may include another server that allows user devices 110 to obtain a client application associated with interacting in network 100.

In addition, various functions are described below as being performed by particular components in network 100. In other implementations, various functions described as being performed by one device may be performed by another device or multiple other devices, and/or various functions described as being performed by multiple devices may be combined and performed by a single device.

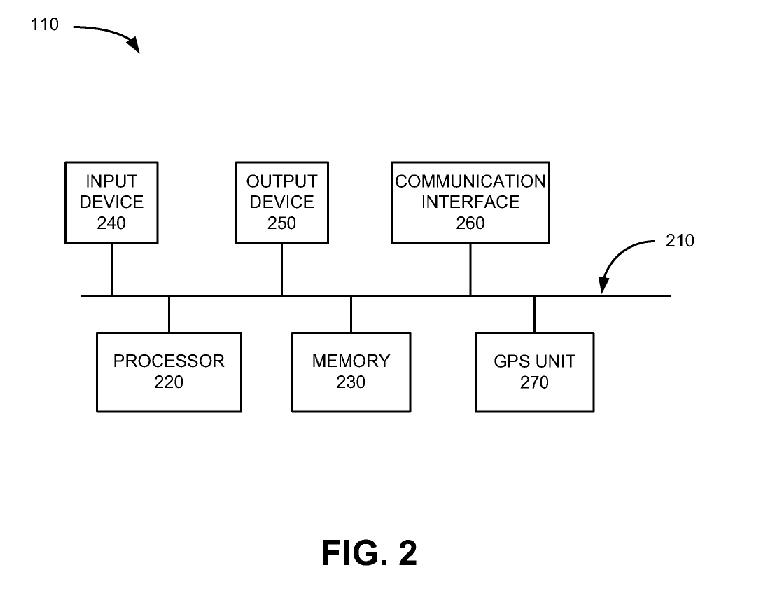

FIG. 2 illustrates an exemplary configuration of user device 110. Other devices in network 100, such as service provider systems 122 and server 130 may be configured in a similar manner. Referring to FIG. 2, user device 110 may include bus 210, processor 220, memory 230, input device 240, output device 250, communication interface 260 and global positioning system (GPS) unit 270. Bus 210 may include a path that permits communication among the elements of user device 110.

Processor 220 may include one or more processors, microprocessors, or processing logic that may interpret and execute instructions. Memory 230 may include a random access memory (RAM) or another type of dynamic storage device that may store information and instructions for execution by processor 220. Memory 230 may also include a read only memory (ROM) device or another type of static storage device that may store static information and instructions for use by processor 220. Memory 230 may further include a solid state drive (SDD). Memory 230 may also include a magnetic and/or optical recording medium (e.g., a hard disk) and its corresponding drive.

Input device 240 may include a mechanism that permits a user to input information to user device 110, such as a keyboard, a keypad, a mouse, a camera, a pen, a microphone, a touch screen, voice recognition and/or biometric mechanisms, a radio frequency (RF) device, a near field communication (NFC) device, etc. Output device 250 may include a mechanism that outputs information to the user, including a display (e.g., a liquid crystal display (LCD)), a printer, a speaker, etc. In some implementations, a touch screen display may act as both an input device and an output device.

Communication interface 260 may include one or more transceivers that user device 110 (or service provider systems 122 or server 130) uses to communicate with other devices via wired, wireless or optical mechanisms. For example, communication interface 260 may include one or more radio frequency (RF) transmitters, receivers and/or transceivers and one or more antennas for transmitting and receiving RF data via network 140. Communication interface 260 may also include a modem or an Ethernet interface to a LAN or other mechanisms for communicating with elements in a network, such as network 140 or another network.

GPS unit 270 may include a GPS receiver that may be used for determining a location of user device 110. The location information may be used by other devices in network 100 (e.g., server 130 and/or service provider systems 122) to identify sites 120 located within a predetermined distance of user device 110.

The exemplary configuration illustrated in FIG. 2 is provided for simplicity. It should be understood that user device 110 (or service provider system 122 or server 130) may include more or fewer devices than illustrated in FIG. 2. In an exemplary implementation, user device 110 (or service provider system 122 and server 130) perform operations in response to processor 220 executing sequences of instructions contained in a computer-readable medium, such as memory 230. A computer-readable medium may be defined as a physical or logical memory device. The software instructions may be read into memory 230 from another computer-readable medium (e.g., a hard disk drive (HDD), SSD, etc.), or from another device via communication interface 260. Alternatively, hard-wired circuitry may be used in place of or in combination with software instructions to implement processes consistent with the implementations described herein. Thus, implementations described herein are not limited to any specific combination of hardware circuitry and software.

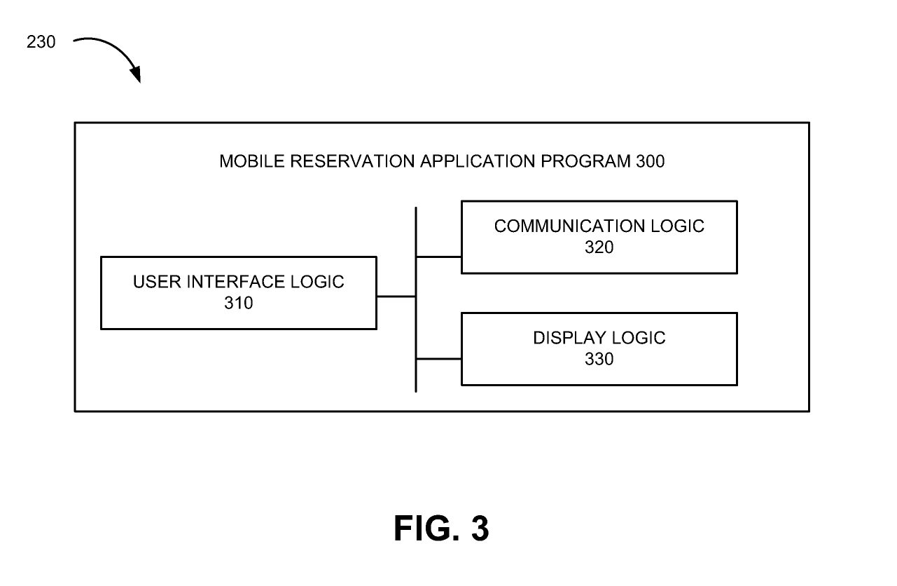

FIG. 3 is an exemplary functional block diagram of components implemented in user device 110 of FIG. 2. In an exemplary implementation, all or some of the components illustrated in FIG. 3 may be stored in memory 230. For example, referring to FIG. 3, memory 230 may include mobile reservation application (MRA) program 300. MRA program 300 may include software instructions executed by processor 220 that allows a party associated with user device 110 to identify and/or reserve services at sites 120.

MRA program 300 may include user interface logic 310, communication logic 320 and display logic 330. MRA program 300 and its various logic components are shown in FIG. 3 as being included in user device 110. In alternative implementations, these components or a portion of these components may be located externally with respect to user device 110. For example, all or a portion of these components may be implemented elsewhere in network 100, such as via a “cloud based” application.

User interface logic 310 may include logic to facilitate entry of information associated with requesting information from or sending information to server 130. For example, user interface logic 310 may include a graphical user interface (GUI) that allows a user to easily enter information to request information associated with various services available at one or more of sites 120.

Communication logic 320 may include logic for communicating with other devices in network 100. For example, communication logic 320 may transmit and/or receive information to/from server 130 via wireless and/or wired mechanisms.

Display logic 330 may include logic to display information received from, for example, server 130. In one exemplary implementation, display logic 330 may output information to output device 250, such as an LCD or another type of display. For example, in one implementation, display logic 330 may display information identifying an available shower at one or more of sites 120, as described in detail below.

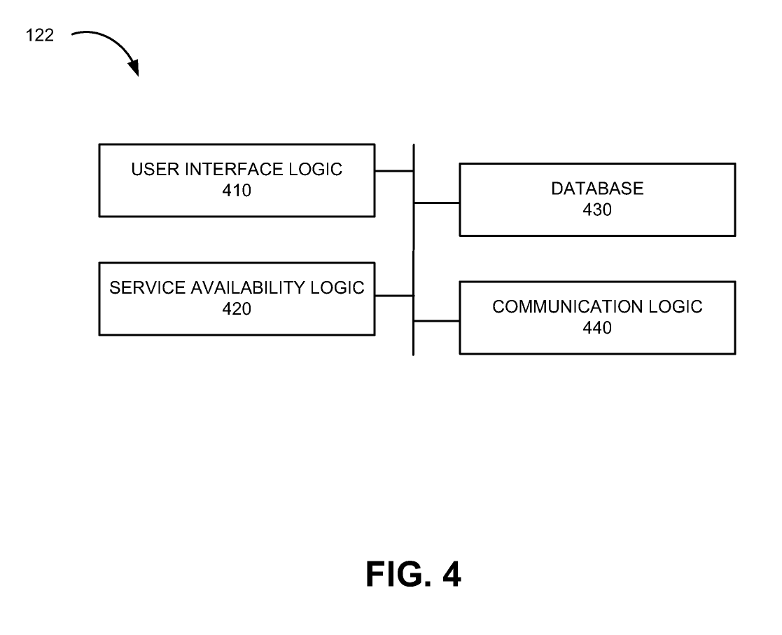

FIG. 4 illustrates an exemplary configuration of logic components implemented in service provider system 122. Referring to FIG. 4, service provider system 122 may include user interface logic 410, service availability logic 420, database 430 and communication logic 440. It should be understood that service provider system 122 may include more or fewer logic devices than illustrated in FIG. 4.

User interface logic 410 may include logic to facilitate entry of information associated with service provider system 122. For example, user interface logic 410 may include a GUI that allows a party associated with a particular one of sites 120 to easily enter information associated with available services at the particular site.

Service availability logic 420 may include logic to determine, for example, the number of available (e.g., not occupied) parking spaces at the site 120 associated with service provider system 122, the number of currently available showers at the particular site 120, an estimated wait time for a shower at site 120, the availability and/or wait time for a mechanic at site 120, etc. In some implementations, service availability logic 420 may include or interface with automated systems or other mechanisms for obtaining this availability information.

Database 430 may include one or more databases storing information gathered by service availability logic 420 and/or input by personnel via user interface logic 410. For example, database 430 may store information identifying the number of available parking spaces, the number of available showers, the availability of a mechanic, etc. This information may be gathered by personnel and/or by automated systems at sites 120.

For example, in one implementation, personnel associated with site 120 may periodically walk the parking lot and count the number of available spaces. In other implementations, sensors and/or cameras located adjacent the parking spaces may automatically provide information to service provider system 122 identifying available parking spaces.

As another example, a shower facility at site 120 may be controlled via keypad entry or some other type of secure entry at each shower. When a user enters a shower, he/she may provide an identification code that is transmitted to service provider system 122. Similarly, when a user exits a shower, cleaning personnel or an automated cleaning system may clean the shower and provide another identification code or otherwise indicate that the shower is ready for the next party. In this manner, database 430 may be updated in real time or near real time via manual and/or automatic input.

Communication logic 440 may include logic that allows service provider system 122 to communicate with other devices in network 100 via network 140. For example, communication logic 440 may allow service provider system 122 to communicate with server 130 and/or user device 110 via network 140. In one exemplary implementation, communication logic 440 may periodically transmit updates regarding available services to server 130, as described in more detail below. In other embodiments, server 130 and service provider systems 122 may be co-located or execute on a single system/platform.

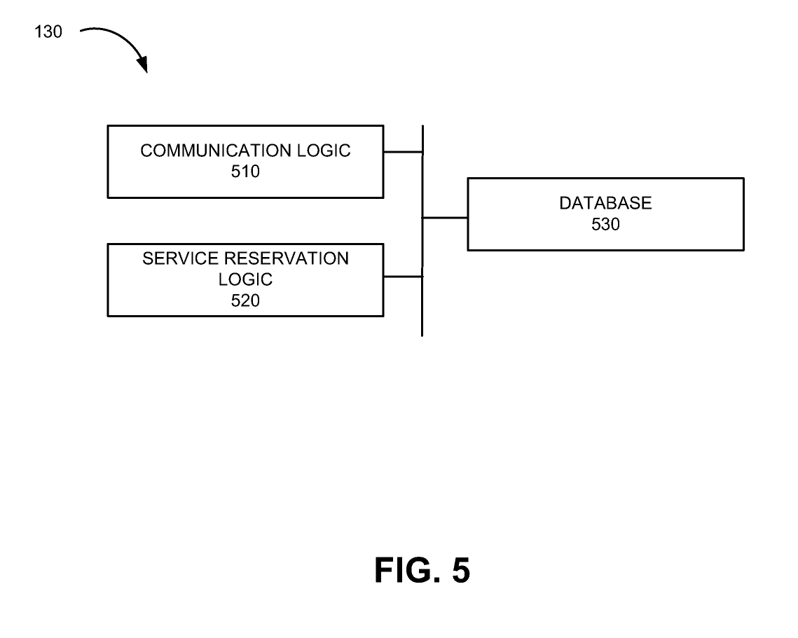

FIG. 5 illustrates an exemplary configuration of logic components implemented in server 130. Referring to FIG. 5, server 130 may include communication logic 510, service reservation logic 520 and database 530. It should be understood that server 130 may include more or fewer logic devices than illustrated in FIG. 5.

Communication logic 510 may include logic that allows server 130 to communicate with other devices in network 100 via network 140. For example, communication logic 510 may allow server 130 to communicate with user device 110 and service provider systems 122 via network 140. In one exemplary implementation, communication logic 510 may periodically poll service provider systems 122 for updated information and store the updated information in database 530, as described in more detail below. Alternatively, service provider systems 122 may periodically forward the information to server 130 at predetermined intervals.

Service reservation logic 520 may include logic to automatically identify whether a user-requested service is available and/or make a reservation for the requested service for the user, based on requests from user device 110. For example, service reservation logic 520 may receive a request from user device 110 for identifying a shower facility available in one of the sites 120 that is located relatively close to user device 110's location. Service reservation logic 520 may access database 530 to identify one of the sites 120 that has shower facilities, as well as identify a waiting time (if any) for a shower. Service reservation logic 520 may also identify available parking spaces at one of the sites 120, whether a mechanic is available at the site 120, etc., based on requests provided via user device 110. Service reservation logic 520 may further make a reservation for one of the services (e.g., a shower), as described in more detail below.

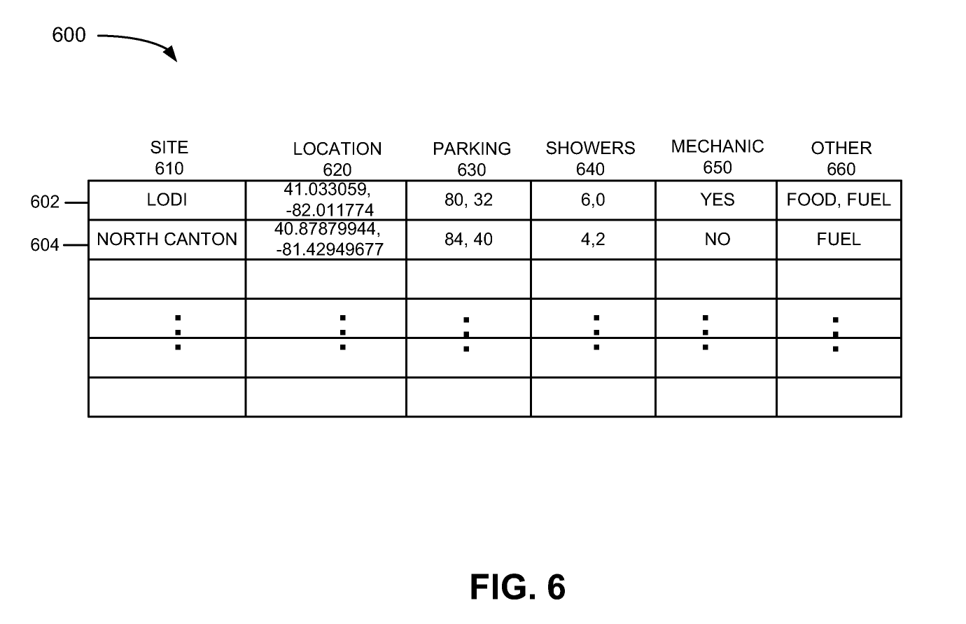

Database 530 may include one or more databases or tables storing information associated with each of sites 120. For example, FIG. 6 illustrates an exemplary table 600 stored in database 530. Referring to FIG. 6, table 600 includes a site field 610, a location field 620, a parking field 630, a showers field 640, a mechanic field 650 and other field 660.

Site field 610 includes information identifying each of sites 120 by name. For example, site field 610 may include the names of various travel centers or truck stops and/or the city in which they are located. Location field 620 stores information identifying a geographical location of the sites in field 610. For example, location field 620 in entry 602 stores latitude and longitude coordinates associated with the Lodi Travel Center identified in field 610 of entry 602.

Parking field 630 may store information identifying a total number of parking spaces and the number of currently available parking spaces at site 120 identified in site field 610. For example, parking field 630 in entry 602 indicates that the Lodi Travel Center has 80 parking spaces and 32 are currently available. In other implementations, parking field 630 may indicate the total number of parking spaces at site 120 identified in field 610 and another database/table may store information indicating the number of available parking spaces.

Showers field 640 may store information identifying a total number of showers and the number of showers currently available at site 120 identified in site field 610. For example, shower field 640 of entry 602 may indicate that the Lodi Travel Center includes 6 showers and that none of the showers are currently available. In other implementations, showers field 640 may indicate the total number of showers at site 120 identified in field 610 and another database/table may store information indicating the number of available showers.

Mechanic field 650 may store information identifying whether a mechanic is available at site 120 identified in field 610 and/or the particular mechanical services that are available (e.g., oil change, brake work, engine work, etc.). For example, mechanic field 650 in entry 602 indicates that a mechanic is on duty at the Lodi Travel Center. Mechanic field 650 may also store information indicating the number of service bays that exist and/or are available for service work at site 120 identified in field 610.

Other field 660 may store information identifying other services available at site 120 identified in field 610, such as whether any restaurants are included at site 120, whether free Wi-Fi is available at site 120, the cost of fuel at site 120, the current weather/temperature at site 120, etc.

In an exemplary implementation, service reservation logic 520 may access database 530, identify information associated with a request from user device 110 and provide the desired information, as described in detail below.

In an exemplary implementation, the logic components illustrated in FIGS. 3-5 may include one or more processors, microprocessors or other processing logic, such as processor 220 (FIG. 2) used to interpret and execute instructions. In such implementations, the logic components may include software instructions stored in a computer-readable medium, such as memory 230. A computer-readable medium may be defined as one or more memory devices. The software instructions may be read into memory from another computer-readable medium or from another device via a communication interface. The software instructions contained in memory may cause the various logic components to perform processes that are described below. Alternatively, hardwired circuitry may be used in place of or in combination with software instructions to implement the logic processes consistent with the exemplary embodiments. Thus, systems and methods described herein are not limited to any specific combinations of hardware circuitry, firmware, and software.

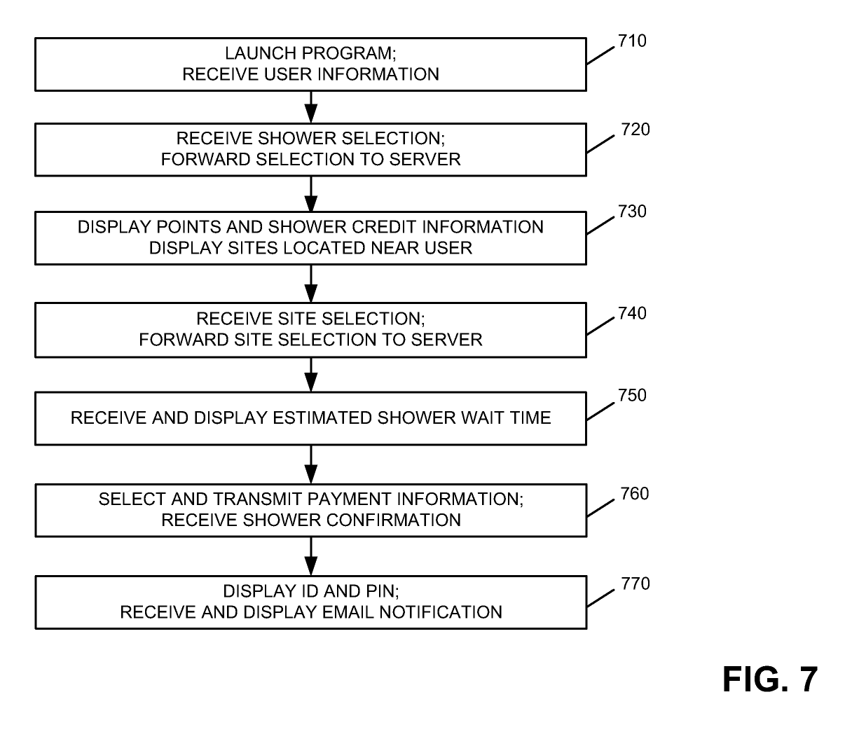

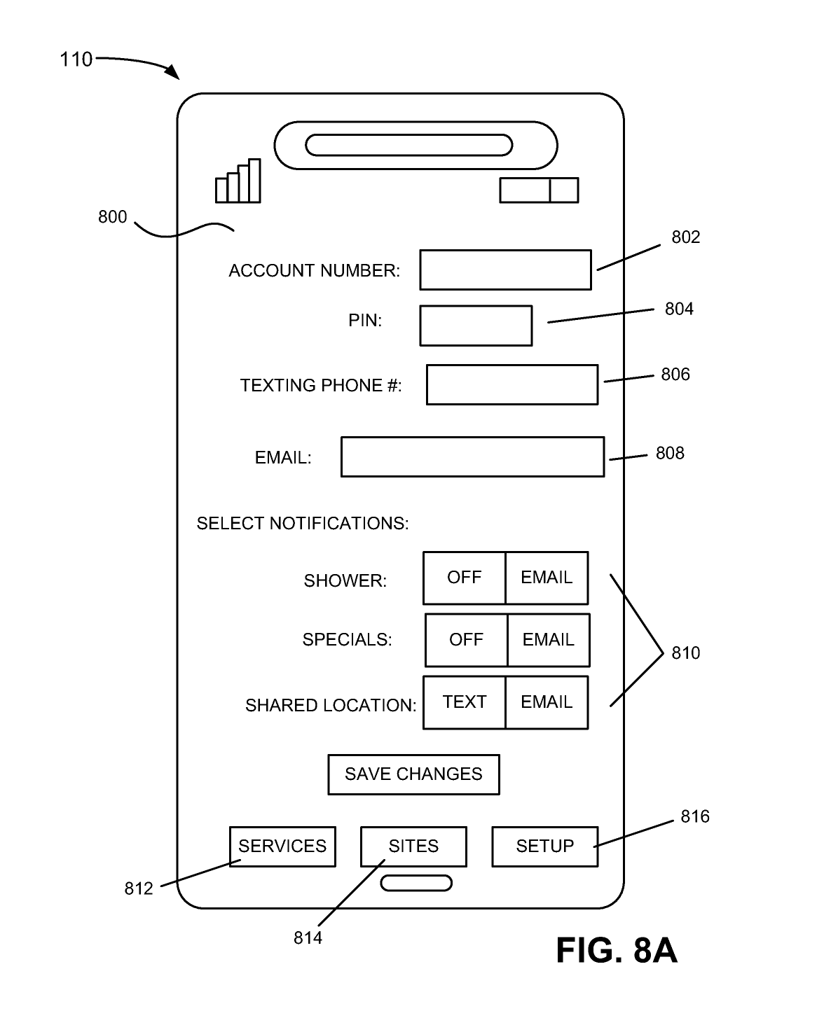

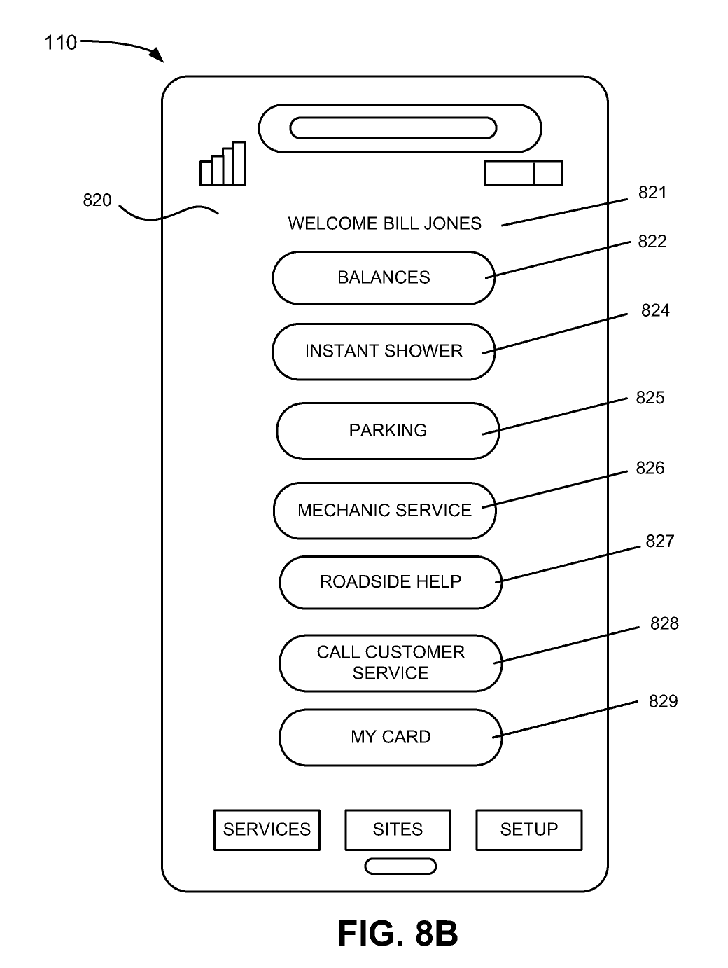

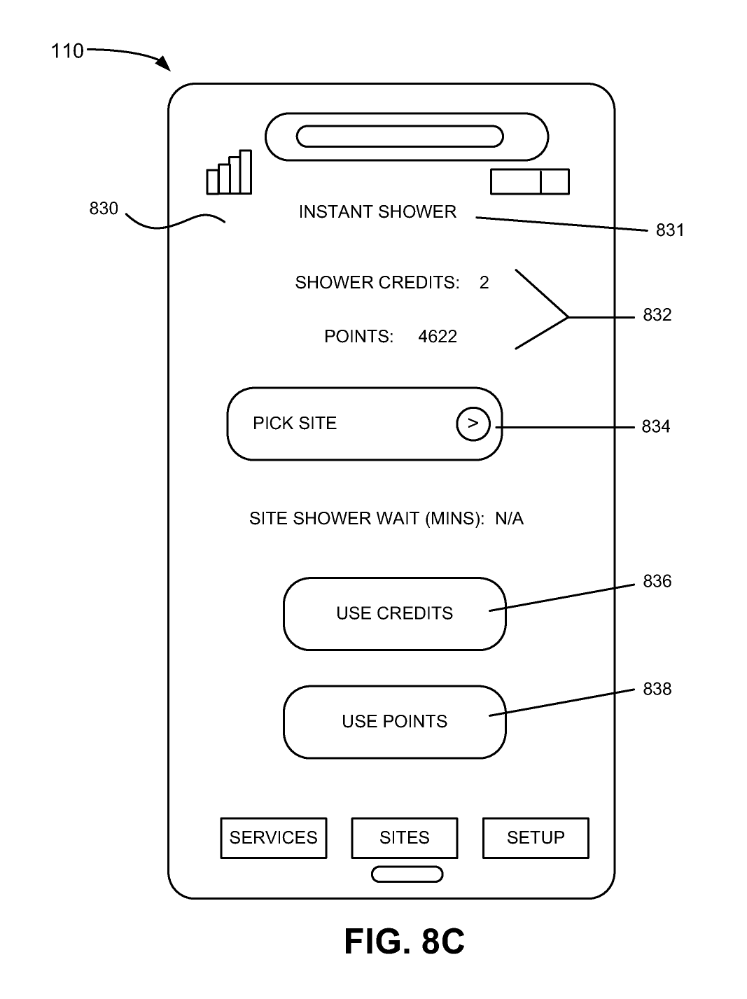

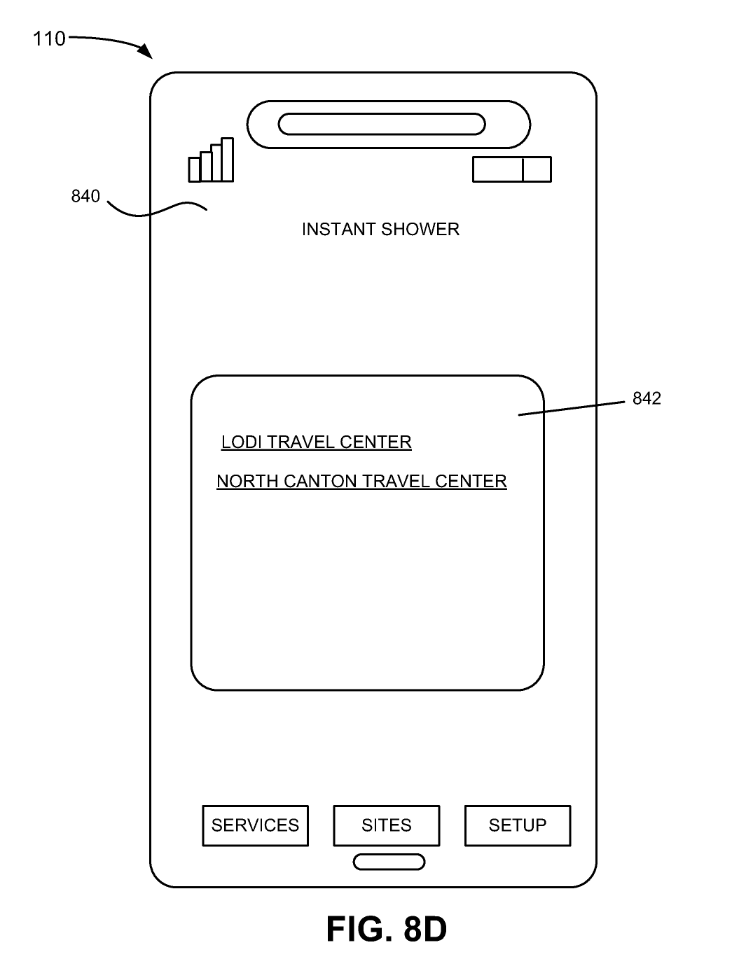

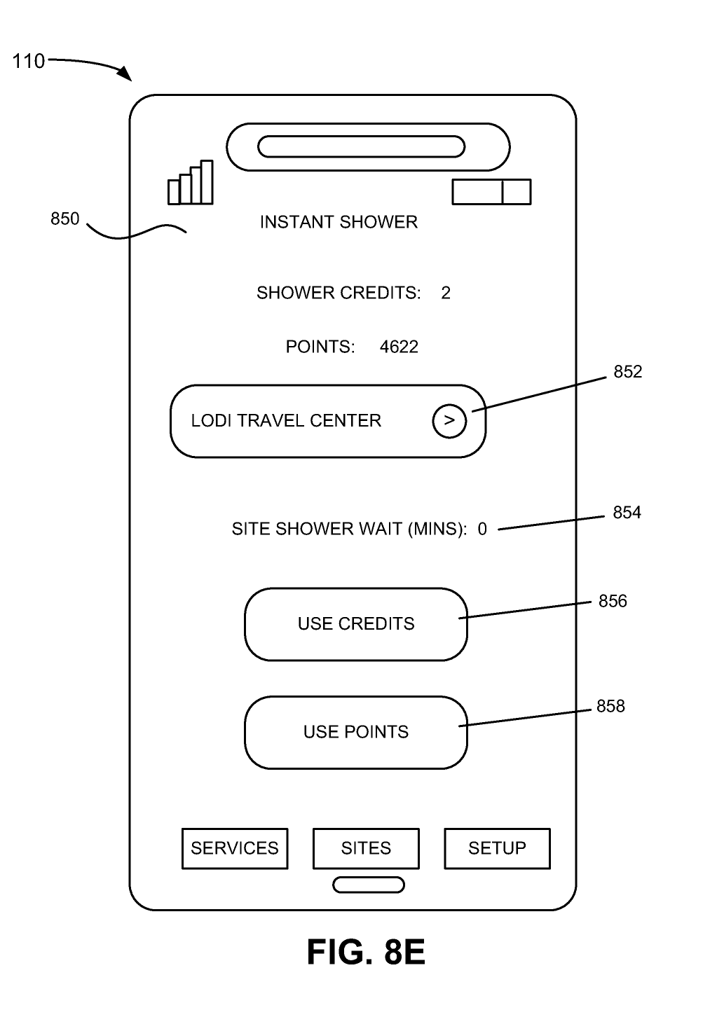

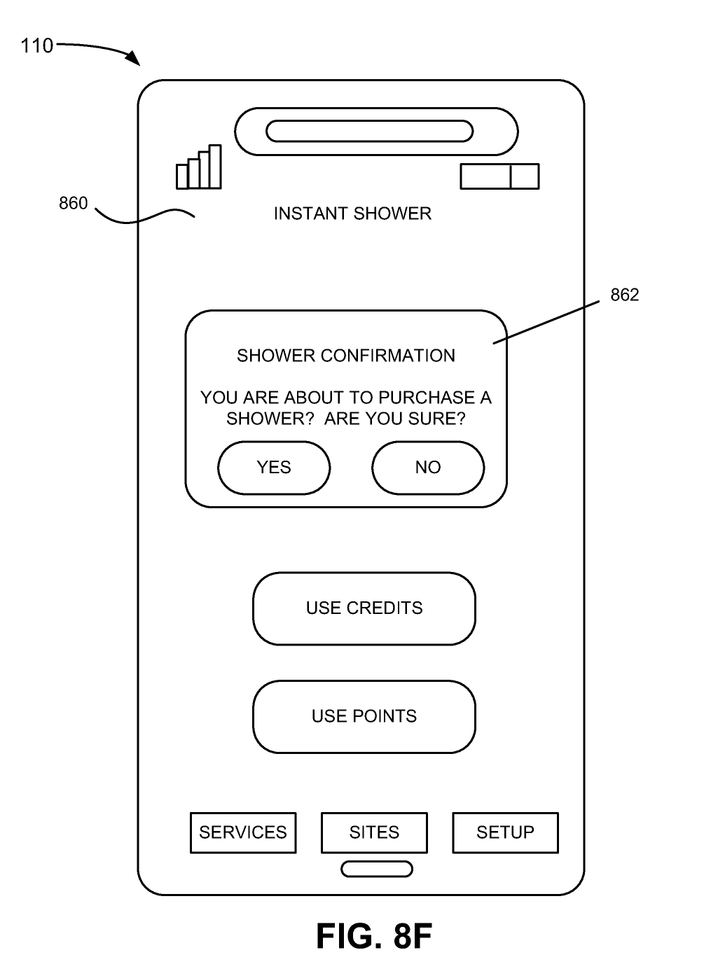

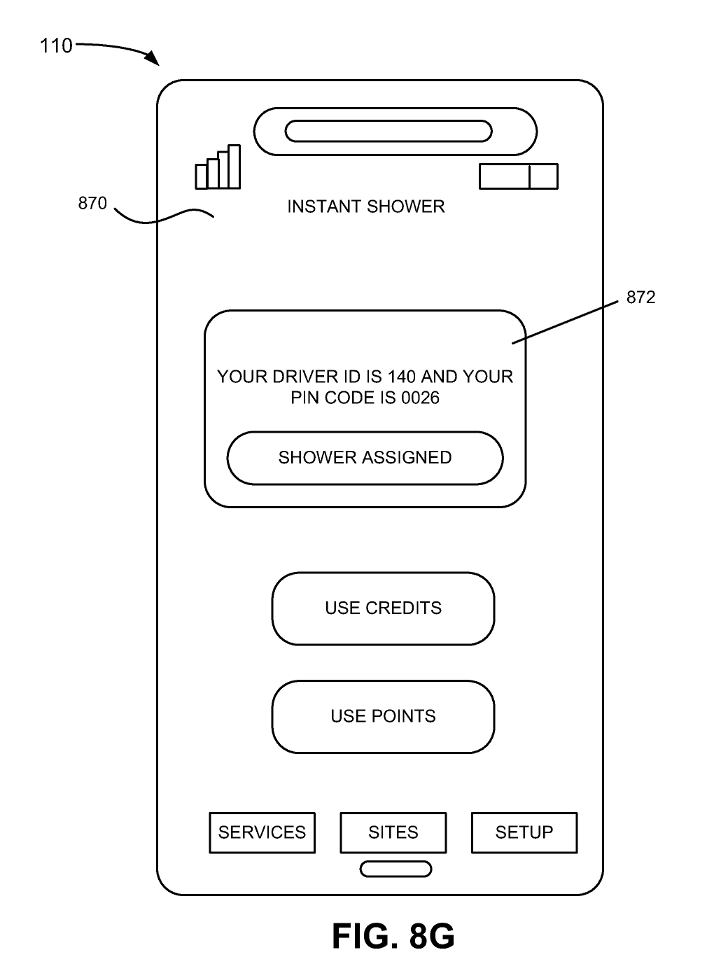

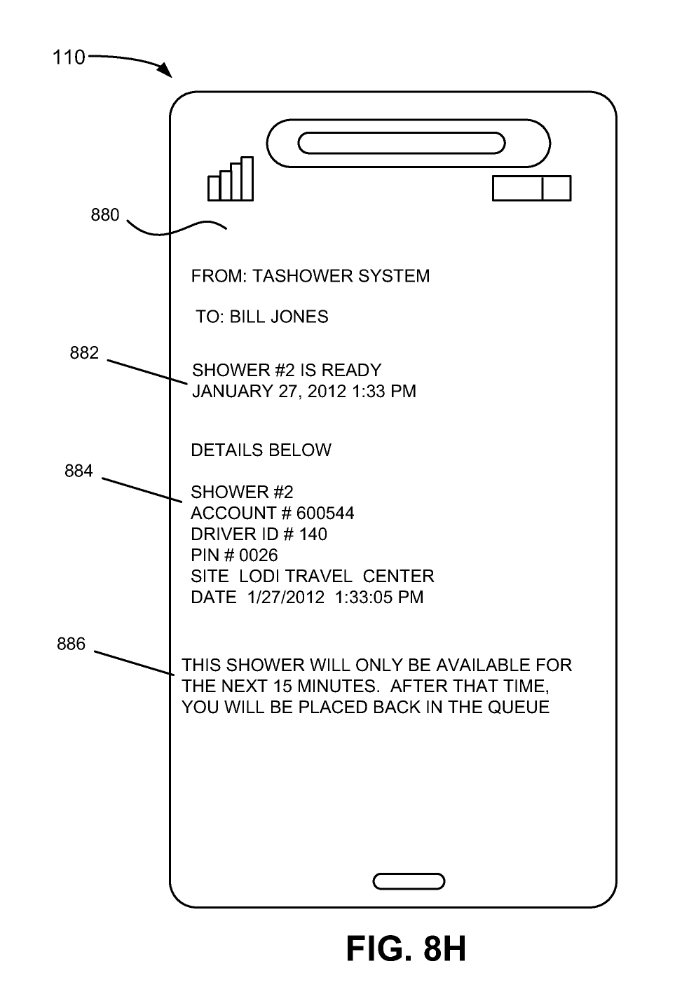

FIG. 7 is a flow diagram illustrating exemplary processing associated with identifying available services and/or making reservations in network 100 via user device 110. In this example, assume that the user associated with user device 110 (also referred to herein as the driver or customer) is driving a vehicle (e.g., a commercial truck) and would like to identify a site 120 (e.g., a travel center or truck/rest stop) that includes a shower facility. Processing may begin with the user launching MRA program 300 in user device 110 (block 710). For example, the user may launch MRA program 300 via a menu or graphical interface displaying a number of application programs stored in user device 110. Further assume that GPS unit 270 in user device 110 is enabled/turned on. In this implementation, assume that user device 110 is a smart phone with an LCD touch screen. Display logic 330 of MRA program 300 may output a user interface (UI) screen via output device 250 of user device 110, as illustrated in FIG. 8A. Referring to FIG. 8A, display logic 330 may output UI screen 800. Screen 800 may represent a set-up or start-up screen associated with MRA program 300. For example, screen 800 may include input box 802 for entering an account number and an input box 804 for entering a personal identification number (PIN). The account number may correspond to a loyalty account in which the user gains points, coupons, lower fees, free items, etc., based on frequency of purchases. The PIN may be the user's personal code used to ensure security with respect to use of MRA program 300.

After the user enters his/her account number and PIN (block 710), MRA program 300 and/or server 130 may automatically populate texting phone number box 806 and email box 808, if the user has previously interacted with MRA program 300 and provided this information. If the user is interacting with MRA program 300 for the first time, the user may enter the telephone number associated with user device 110 in box 806 and an email address at which he/she would like to receive notifications from server 130 in box 808.

UI screen 800 may also include a notifications area 810 that allows the user to select particular types of notifications that he/she may receive from server 130, such as notifications associated with a shower, special offers, shared location information, etc. For example, if the user selects/click the “email” button at area 810 corresponding to the shower selection, he/she will be notified via email when a shower at a particular site is available. Similarly, the user may select email notification for special offers and select text or email notification for sharing location information with other users and devices interacting with server 130.

UI screen 800 may further include services button 812, sites button 814 and setup button 816. Services button 812 may allow the user to identify services that are available at sites 120. Sites button 814 may allow the user to identify the names and locations of sites 120 and setup button 816 may allow the user to change various information in his/her profile, such as information in UI screen 800.

Assume that the user selects (e.g., via a touch or a click via a cursor) services button 812 to identify available services. User interface logic 310 may receive the selection and display logic 330 may output UI screen 820, as illustrated in FIG. 8B. UI screen 820 may include a personalized message at area 821, such as “Welcome Bill Jones,” along with a number of options at input buttons 822-829. The message at area 821 may be based on personal information (e.g., name, address, etc.) provided by the user when he/she first interacted with MRA program 300. Buttons/selections 822-829 are exemplary only. In other implementations, some of buttons 822-829 may be provided on a different UI screen or not provided. In addition, other buttons associated with services that are available may be provided in other implementations.

Balances button 822 may correspond to a selection that allows the user to identify any balances the user may have, such as the number of customer loyalty points, the number of free shower credits, any free coupons, etc. Instant shower button 824 may allow the user to identify available shower facilities at sites 120. Parking button 825 may allow the user to identify available parking spaces at sites 120. Mechanic service button 826 may allow the user to identify whether sites 120 have an on-duty mechanic and/or determine the number of service bays at sites 120. Roadside help button 827 may allow the user to contact server 130 to receive roadside assistance. Call customer service button 828 may allow the user to establish a voice and/or text link with customer service. My card button 829 may allow the user to obtain information regarding his/her account/loyalty card.

Assume that the user selects Instant Shower button 824. User interface logic 310 receives the selection (block 720). Communication logic 320 may then contact server 130 to obtain the user's loyalty account balances (e.g., points and shower credits) via, for example, a Web service call/communication over network 140 to server 130 (block 720). Server 130 may receive the communication from user device 110 and identify the particular customer. For example, the communication from user device 110 may include information identifying the particular user/customer. Server 130 may also access a database storing information associated with each of the users and return the user's shower credits and loyalty points.

Server 130 may also access table 600 and identify all sites 120 located within a predetermined distance of user device 110. For example, in one implementation, communication logic 320 at user device 110 may forward the GPS coordinates of user device 110, along with the selection of “Instant Shower.” In some implementations, the geographical location information may also include a direction of travel (e.g., northwest, southeast and/or a direction in degrees). Server 130 may receive the geographical location information of user device 110 and identify all sites 120 within, for example, a 50-mile radius of user device 110 based on user device 110′s current GPS position. Server 130 may forward the identified information (e.g., the user's points, shower credits and sites within the predetermined distance) to user device 110. In implementations in which direction information is provided, server 130 may identify sites 120 within the predetermined radius in a forward direction with respect to the direction in which user device 110 is traveling.

Communication logic 320 at user device 110 may receive the information from server 130 and display logic 330 may output UI screen 830, as illustrated in FIG. 8C (block 730). For example, UI screen 830 may include an Instant Shower screen label at area 831. UI screen 830 may also display the shower credits and loyalty points available to the user at area 832. In this case, UI screen 830 indicates that the user has two shower credits and 4,622 points.

UI screen 830 may further include a Pick Site button 834, a Use Credits button 836 and a Use Points button 838. However, buttons 836 and 838 may be disabled in UI screen 830 until a particular site is selected.

Assume that the user would like to pick a site (corresponding to one of sites 120) to take a shower. In this case, the user may select/click on Pick Site button 834. As described above, server 130 may have previously identified and forwarded information associated with sites 120 located within a 50 mile radius of user device 110. In this case, after receiving the pick site selection via input box 834, display logic 330 may output information identifying the sites located within the predetermined radius, as illustrated in FIG. 8D. For example, referring to FIG. 8D, display logic 330 may output UI screen 840 with information identifying the sites 120 located within the predetermined distance (e.g., 50 miles) of user device 110 at box 842 (block 730). In this example, two sites 120 (i.e., Lodi Travel Center and North Canton Travel Center) were identified.

Assume that the user selects a site where he/she would like to take his/her shower. For example, assume that the user selects the Lodi Travel Center by clicking on the name “Lodi Travel Center” in box 842 (block 740). In this case, communication logic 320 may generate and transmit a Web service call/communication to server 130 that includes credentials/information identifying user device 110, along with information identifying the selected site 120 (block 740). For example, in one implementation, the communication may include the IP address associated with the site 120 selected by the user (i.e., the Lodi Travel Center in this example). That is, MRA program 300 may store IP addresses associated with each of sites 120. In other instances, server 130 may receive the selection identifying the Lodi Travel Center and identify the appropriate IP address associated with the selected site. In either case, communication logic 510 at server 130 receives the request and may attempt to open a communication socket directly to the selected site 120.

Continuing with the above example in which the selected site 120 corresponds to the Lodi Travel Center, server 130 may open a communication link/socket via, for example, a remote procedure call (RPC) to service provider system 122 at the Lodi Travel Center. Further assume that service provider system 122 at the Lodi Travel Center includes or interfaces with an automated shower system in which information identifying available showers and/or wait times associated with showers is stored. In this case, service reservation logic 520 at server 130 may identify whether a shower is currently available and/or an approximate wait time for a shower at the Lodi Travel Center.

For example, in one implementation, database 430 may include a table storing information identifying a number of people in the shower queue, an estimated shower time, an estimated time to clean a shower and an estimated lag time for someone whose shower is available until the time the person actually enters the shower. As an example, assume that the Lodi Travel Center site 120 includes six showers and that eight people are in the shower queue and that no showers are currently occupied. Further assume that the estimated shower time is ten minutes, the estimated time to clean a shower is eight minutes and the estimated lag time between the time a shower is available for a user whose shower is available to enter the shower is four minutes. In this case, service availability logic 420 at service provider system 122 may calculate that the estimated wait time is equal to (8×(10+8+4))/6 or 29.3 minutes. As another example, if the Lodi Travel Center includes four showers and no people are in the queue, service availability logic 420 may determine that the estimated wait time is zero minutes. In an exemplary implementation, service availability logic 420 may dynamically calculate a user's estimated wait time in real time. That is, when service availability logic 420 receives a request for a shower, service availability logic 420 may identify the current number of users in the queue, the current estimate associated with an estimated shower time, the current estimate of the time to clean a shower and the current estimate of the lag time for someone whose shower is available to enter the shower, to calculate the user's estimated wait time.

In an exemplary implementation, service availability logic 420 may estimate the average shower time, average cleaning time and average lag time using actual data associated with user showers obtained over a period of time, such as the previous 15 days. That is, when a user enters a shower, the user enters a code, such as a personal identification number (PIN) code. Similarly, when cleaning personnel enter a recently used shower, he/she enters a different PIN and provides a second PIN when he/she has finished cleaning the shower. Service provider system 122 receives all of this information and generates an estimated wait time using data gathered over a previous period of time, such as the last 15 day cycle. Service availability logic 420 may then generate a more accurate estimate of wait times, which may fluctuate based on the time of year (e.g., summer versus winter and/or other factors).

In some implementations, service availability logic 420 may also take into consideration the time of day or day of week in which the request was made. For example, using data from the previous cycle, service availability logic 420 may determine that the average shower time changes based on the time of day and/or day of week. In this case, service availability logic 420 may use a different estimated shower time based on the time of day and/or day of the week.

In each case, service provider system 122 at the selected site 120 receives the request. Service availability logic 420 may then identify an approximate current wait time for a shower at the selected site 120. Communication logic 440 may forward the approximate wait time to server 130. Server 130 receives the wait time and may then forward the estimated shower wait time to user device 110. User device 110 receives the estimated wait time and display logic 330 may update the Instant Shower screen, as illustrated by UI screen 850 in FIG. 8E (block 750). Referring to FIG. 8E, UI screen 850 indicates the selected site 120 (i.e., Lodi Travel Center in this example) at box 852. UI screen 850 at area 854 also indicates that the current wait time for a shower at the Lodi Travel Center is zero minutes. Display logic 330 may also enable the “Use Credits” button 856 and “Use Points” button on UI screen 850 since a particular site 120 has been selected.

If service provider system 122 at the selected site 120 rejects the request or there is a problem with the transaction, server 130 may provide information to user device 110 to inform the user that his/her request cannot be processed at this time and to try again later. In this case, the “Use Credits” and “Use Points” buttons 856 and 858 remain disabled.

From UI screen 850, assume that the user chooses a payment method via Use Credits button 856 or Use Points button 858 (block 760). In other implementations, UI screen 850 may include an option to pay by credit or debit card. In each case, upon receiving a selected payment method, user device 110 initiates a communication, such as a Web service call, to server 130 to submit the payment information (block 760). The Web service call may include credentials associated with the user, the IP address of the selected site, the payment method selected, and the notification type (default notification may be set as email) and the email address (obtained via the Setup screen illustrated in FIG. 8A) via which to notify the user.

Server 130 may handle the payment settlement to the loyalty system to reduce the user's shower credits and/or loyalty points based on the selected payment method. If server 130 identifies any problem with respect to the selected payment method, server 130 may forward a communication to user device 110 identifying the driver of the problem. For example, if a problem occurs, the driver is notified that he/she cannot request a remote shower at this time and the process is aborted.

Assume that the payment settlement is successfully received and processed. Server 130 may then attempt to open a communication socket or link directly to service provider system 122 (e.g., the automated shower system located at site 120 and/or implemented within service provider system 122). For example, server 130 may send an RPC to service provider system 122 to enter the driver into the shower queue.

Service provider system 122 processes the request and returns the driver's ID and password back to server 130. Server 130 may then send a communication via a Web service call/communication to user device 110. The communication includes the ID and PIN code/password associated with the shower. Communication logic 320 at user device 110 receives the communication and display logic 330 outputs a popup screen to confirm the shower request, as illustrated in FIG. 8F. For example, display logic 330 may provide UI screen 860 which includes a “pop up” type message overlaid on the Instant Shower screen. In this case, pop up window 862 provides the message “You are about to purchase a shower. Are you sure?” and provides “yes” and “no” selections in pop up window 862.

If the user confirms by selecting “yes” (block 760), user device 110 pops a message to the user indicating the driver ID and a PIN code (block 770), as illustrated in FIG. 8G. For example, referring to FIG. 8G, UI screen 870 includes pop up window 872 that provides a driver ID and PIN for the shower, along with a message that the shower has been assigned to the user. In some implementations, pop up window 872 may also provide a message indicating that an email will be sent to the user's email address once the shower is ready.

For example, once a shower becomes available and the driver gets assigned to a particular shower at site 120, server 130 may send an email to user device 110 providing information associated with the shower. For example, server 130 may transmit an email to user device 110 (block 770). The user may open the email for display via output device 250, as illustrated in FIG. 8H (block 770). Referring to FIG. 8H, email 880 may include information indicating that shower #2 is ready at area 882. Email 880 may also include the driver ID and PIN for the reserved shower at area 884. Email 880 may further include a message at area 886 indicating that the shower will be reserved for 15 minutes and that if the driver does not enter the shower within 15 minutes, he/she will be placed back in the shower queue.

In this manner, a driver who is on the road may interact with server 130 to identify a shower facility located relatively close to his/her current location and may optionally make a reservation at a particular site. Server 130 may then automatically make the reservation for the driver and the driver never has to contact any person at the selected site. This may allow the driver to maintain his/her schedule in an efficient manner.

As described above, user device 110 may interact with server 130 and/or service provider systems 122 to obtain information regarding various services, such as the availability of shower facilities at sites 120. User device 110 may also be used to identify other types of services, such as available parking spaces at one of sites 120.

For example, in an exemplary implementation, each of service provider systems 122 may allow for personnel at sites 120 to enter available parking counts at the particular site 120. In this implementation, user interface logic 410 may include a GUI that allows personnel to update the available parking spaces at the site throughout the day, such as every one hour, every two hours, etc. Database 430 may store this information.

In an exemplary implementation, service provider system 122 may forward the parking count information to server 130 at various intervals throughout the day, such as every hour, every two hours, etc. In other instances, server 130 may poll service provider systems 122 to obtain the parking information. In either case, server 130 may store information regarding available parking spaces for each of sites 120 in, for example, table 600. For example, referring to table 600 (FIG. 6), parking field 630 may store information identifying the total number of parking spaces at each site 120 and the number of spaces that are currently available. As an example, field 630 of entry 604 indicates that the North Canton site 120 includes 84 parking spaces and that 40 are currently available.

In this implementation, a user may request parking information by selecting services button 812 on UI 800 illustrated in FIG. 8A. Display logic 330 may display UI screen 820, as described above with respect to FIG. 8B. Referring to FIG. 8B, UI screen 820 may include a parking button 825. Assume that the user selects parking button 825. Similar to the processing described above with respect to identifying a shower facility, server 130 may receive the parking selection and return information identifying sites 120 located within a predetermined distance of user device 110. Further assume that the user selects a particular site, such as the North Canton site 120. Upon receiving the selection of a specific site, user device 110 may make a Web service call to retrieve the current available parking count from server 130 for the North Canton site 120.

Server 130 receives the request, accesses table 600 and identifies the current parking count for the selected site 120 and sends the appropriate information to user device 110. In some implementations, server 130 does not provide parking counts that are over two hours old, to ensure accuracy of the data. That is, if the North Canton site 120 has not provided parking data within the past two hours, server 130 may not provide a currently available parking count to user device 110. This ensures that stale parking data is not provided to user device 110.

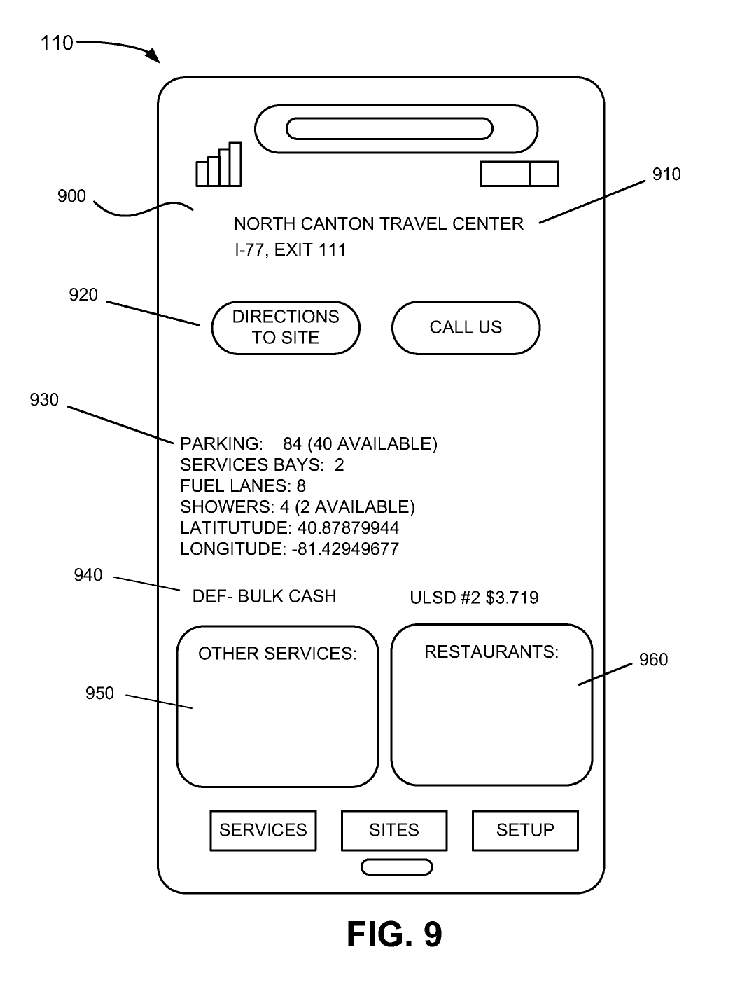

In each case, user device 110 may receive the data from server 130 and display logic 330 may output the available parking counts, as illustrated in FIG. 9. Referring to FIG. 9, UI screen 900 may include the name of site 120 at area 910 (i.e., the North Canton Travel Center in this example) and input buttons for obtaining directions to site 120 and calling site 120 at area 920. UI screen 900 may also include information at area 930 identifying the total number of parking spaces (i.e., 84 in this example) and the number of those spaces that are currently unoccupied (i.e., 40 in this example). In some implementations, UI screen 900 may also include, at area 930, information indicating the number of service bays, the number of fuel lanes and the number of showers, including the number of currently available showers and the geographical location of site 120, as illustrated in FIG. 9.

Still further, UI screen 900 may include information identifying the price of fuel at area 940 and the availability of other services at area 950 and restaurants at area 960. In some implementations, the user may select a particular restaurant displayed at area 960 and reserve a spot at the restaurant and/or get on a waiting list at the selected restaurant. In this case, user device 110 may send the request to server 130 and server 130 may interact with a restaurant reservation system to make a reservation and/or place the user in a queue at the selected restaurant.

As described above, user device 110 may interact with server 130 and/or service provider locations 120 to obtain information regarding various services, such as the availability of shower facilities, available parking spaces, etc. User device 110 may also be used to identify other types of services, such as road services that are available and may be dispatched to aid a driver/vehicle experiencing mechanical problems or other problems.

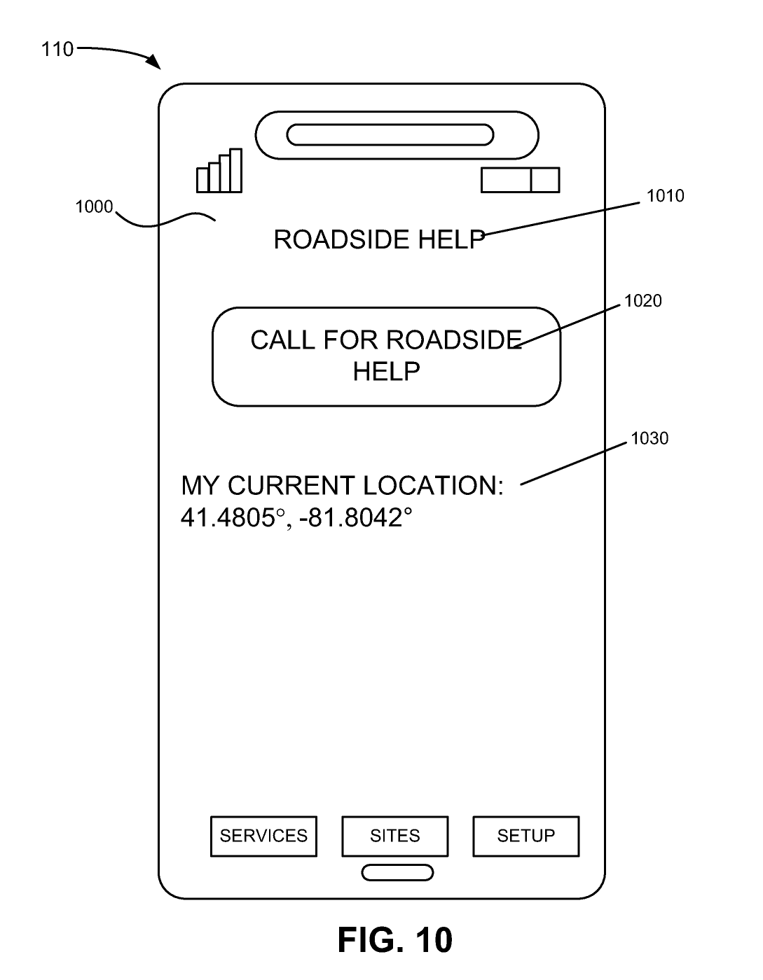

For example, UI screen 820 illustrated in FIG. 8B may include a Roadside help button 827, as described above with respect to FIG. 8B. Assume that the user selects Roadside help button 827. Display logic 330 may output UI screen 1000, as illustrated in FIG. 10. Referring to FIG. 10, UI screen 1000 includes a Roadside help label at area 1010, a call for roadside help button at area 1020 and the user's current location at area 1030. If the user selects, call roadside help button 1010, MRA program 300 may automatically send a communication to server 130.

Server 130 may receive the communication, which may then forward the communication to a roadside repair call center. Based on the location of user device 110, server 130 and/or the roadside repair call center dispatches a repair technician to the specific location associated with user device. For example, the initial communication generated in response to selection of the call for roadside help button 1020 includes the geographical coordinates of user device 110. Server 130 and/or the call center use this location to dispatch a repair crew located close to the user's location.

In some implementations, MRA program 300 may be programmed with a telephone number associated with obtaining roadside assistance. In this implementation, when the user selects the Call for Roadside Help button 1020, user device 110 automatically places a call to the call center and the receiving agent will know that the call was made by an MRA program 300. In addition, when the call is made, user device 110 forwards a Web service call that includes user device 110's current location. As a result, the agent that answers the call displays the coordinates of the call. The agent may also confirm the coordinates with the user. Once the coordinates are confirmed, the agent processes the rest of the call, which includes sending the confirmed coordinates to the road services technician located closest to the caller's location. The technician enters the coordinates into his/her GPS, which allows him/her to efficiently and accurately get to the road side call. In this manner, MRA program 300 may allow the user to quickly obtain help in case his/her car or truck breaks down on the road.

Implementations described herein allow a user to obtain information regarding services that may be available at one or more sites. As described above, an application program stored on a mobile device may allow a user who is driving to obtain information regarding the availability of shower facilities, parking, mechanical services, roadside repair services, etc., without having to individually contact any particular sites. The program may also allow the user to optionally make reservations without having to call any particular site. This may allow the user to efficiently plan his/her trip.

The foregoing description of exemplary implementations provides illustration and description, but is not intended to be exhaustive or to limit the embodiments to the precise form disclosed. Modifications and variations are possible in light of the above teachings or may be acquired from practice of the embodiments.

For example, features have been described above with respect to MRA program 300 interacting with server 130 to obtain information from service provider systems 122 located at various sites. In other implementations, MRA program 300 may communicate with various service provider systems 122 directly to obtain information and/or make reservations.

In addition, processing has been described above with respect to making a reservation for a shower facility. In some implementations, a user may make reservations for mechanic services at one of sites 120 and be provided with an estimated wait time for various services, such as an oil change, engine work, etc.

Still further, processing has been described above with respect to identifying a current wait time with respect to a shower. In other implementations, service availability logic 420 at service provider system 122 or service reservation logic 520 at server 130 may take into consideration the location of user device 110 when providing an approximate wait time. For example, if the driver is approximately 30 miles away from the selected site 120 and all showers are currently occupied, service availability logic 420 may estimate that when the user/driver arrives, the wait time will be 10 minutes based on, for example, the number of people in the queue ahead of the driver. That is, service availability logic 420 and/or service reservation logic 520 may estimate the driver's arrival time and then estimate the wait time for a shower at that time.

In addition, features have been described above with respect to a driver identifying services at a site, such as a travel center or truck/rest stop. It should be understood that in other implementations, MRA program 300 may identify other types of services at other types of sites. That is, MRA program 300 may interact with server 130 and/or service provider systems 122 to obtain information and make reservations for any type of service in which a retail establishment/vendor accepts reservations.

Further, while series of acts have been described with respect to FIG. 7, the order of the acts may be different in other implementations. Moreover, non-dependent acts may be implemented in parallel.

It will be apparent that various features described above may be implemented in many different forms of software, firmware, and hardware in the implementations illustrated in the figures. The actual software code or specialized control hardware used to implement the various features is not limiting. Thus, the operation and behavior of the features were described without reference to the specific software code—it being understood that one of ordinary skill in the art would be able to design software and control hardware to implement the various features based on the description herein.

Further, certain portions of the invention may be implemented as “logic” that performs one or more functions. This logic may include hardware, such as one or more processors, microprocessor, application specific integrated circuits, field programmable gate arrays or other processing logic, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

1. A non-transitory computer-readable medium having stored thereon sequences of instructions which, when executed by at least one processor, cause the at least one processor to:
receive, from a user, a first input associated with identifying a shower facility at a travel center or truck stop;
generate, in response to the first input, a first communication requesting information identifying at least one shower facility;
forward the first communication to a network device associated with an entity operating a plurality of travel centers or truck stops, wherein the first communication includes a geographical location obtained by a geographical positioning system (GPS) unit associated with the user;
receive, from the network device, information identifying a plurality of shower facilities, wherein each shower facility is located at a different one of the plurality of travel centers or truck stops than other ones of the plurality of shower facilities, and each shower facility is located within a predetermined distance of the geographical location obtained by the GPS unit associated with the user;
output, to a display, information identifying names of a plurality of travel centers or truck stops corresponding to the plurality of shower facilities;
receive, from the user, a second input selecting a first one of plurality of shower facilities;
generate, in response to the second input, a second communication requesting that a shower at the first shower facility be reserved for the user; and
receive, from the network device, at least one of a confirmation code or an identification code associated with a reserved shower at the first shower facility.

2. The non-transitory computer-readable medium of claim 1, further including instructions for causing the at least one processor to:
receive and display an electronic mail message or text message when the reserved shower is available.

3. The non-transitory computer-readable medium of claim 1, further including instructions for causing the at least one processor to:
receive, from the user, a third input identifying a payment method for the reserved shower.

4. The non-transitory computer-readable medium of claim 3, wherein the third input identifies one of using shower credits as the payment method or using points as the payment method.

5. (canceled)

6. The non-transitory computer-readable medium of claim 1, further including instructions for causing the at least one processor to:
receive, from the user, a third input associated with identifying available parking spaces at the travel center or truck stop;
generate, in response to the third input, a third communication requesting information identifying a number of available parking spaces at the travel center or truck stop;
forward the third communication to the network device;
receive, from the network device, information identifying at least some of the plurality of travel centers or truck stops, wherein each of the plurality of travel centers or truck stops is located within the predetermined distance of the user;
receive, from the user, a fourth input selecting a first one of the travel centers or truck stops;
forward, from the user, a fourth communication identifying the first travel center or truck stop;
receive, from the network device, information identifying the number of available parking spaces at the first travel center or truck stop; and
output, to a display, information identifying the number of available parking spaces at the first travel center or truck stop.

7. The non-transitory computer-readable medium of claim 1, further including instructions for causing the at least one processor to:
receive, from the user, a third input associated with identifying an availability of vehicle repair or maintenance service at the travel center or truck stop;
generate, in response to the third input, a third communication requesting information identifying the availability of vehicle repair or maintenance services at the travel center or truck stop;
forward the third communication to the network device; and
receive, from the network device, information identifying the availability of vehicle repair or maintenance services at the travel center or truck stop.

8. The non-transitory computer-readable medium of claim 7, further including instructions for causing the at least one processor to:
receive, from the user, a fourth input for reserving or scheduling a vehicle repair or maintenance services at the travel center or truck stop;
generate, in response to the fourth input, a fourth communication requesting the vehicle repair or maintenance service; and
forward the fourth communication to the network device; and
receive, from the network device, information identifying a reserved time slot for the vehicle repair or maintenance service at the travel center or truck stop.

9. (canceled)

10. A computer-implemented method, comprising:
receiving, from a user device, a first communication requesting information identifying a site that includes a shower facility, wherein the first communication includes geographical location obtained by a geographical positioning system (GPS) unit associated with the user device;
accessing a database storing information associated with a plurality of sites;
identifying at least two of the plurality of sites that are located within a predetermined distance of the geographical location associated with the user device, wherein each of the at least two sites includes a shower facility;
forwarding, to the user device, a second communication including information identifying the at least two sites;
receiving, from the user device, a second input selecting a first one of the at least two sites;
determining an estimated wait time associated with the shower facility at the first site; and
forwarding, to the user device, a third communication including information identifying the estimated wait time for the shower facility at the first site.

11. (canceled)

12. The computer-implemented method of claim 10, further comprising:
receiving, from the user device, a fourth communication requesting reservation of a shower at the first site; and
forwarding, to the user device, a fifth communication including a code associated with a reserved shower at the first site.

13. The computer-implemented method of claim 10, wherein the determining an estimated wait time comprises:
identifying a number of people in a queue for the shower facility at the first site, determining an average shower time,
determining an average time for cleaning a shower,
determining an average lag time between a time that a shower is available until a time that a customer enters the shower, and
calculating the estimated wait time based on the number of people in the queue, the average shower time, the average time for cleaning a shower and the average lag time.

14. The computer-implemented method of claim 13, further comprising:
receiving information identifying an average shower time from the first site at predetermined intervals; and
updating the database based on the received information.

15. The computer-implemented method of claim 10, wherein the identifying at least two sites comprises:
determining a location of the user device, and
identifying sites located within the predetermined distance of the user device, and wherein the forwarding comprises:
forwarding information identifying each of identified sites with the second communication.

16. The computer-implemented method of claim 10, further comprising:
receiving, from the user device, a third communication requesting information associated with an availability of vehicle repair or maintenance services at the first site;
accessing the database to identify information associated with the availability of vehicle repair or maintenance services at the first site; and
forwarding, to the user device, a fourth communication including information identifying the availability of vehicle repair or maintenance services at the first site.

17. The computer-implemented method of claim 10, further comprising:
receiving, from the user device, a third communication requesting information identifying an availability of parking spaces at the first site;
accessing the database to identify information corresponding to a number of available parking spaces at the first site; and
forwarding, to the user device, a fourth communication identifying the number of available parking spaces at the first site.

18. The computer-implemented method of claim 10, further comprising:
receiving, from the user device, a third communication requesting road side assistance, wherein the third communication includes location information associated with the user device;
identifying, based on the location information, a road service crew to aid a party associated with the user device; and
dispatching the road service crew to a location based on the received location information.

19. A system, comprising:
at least one first device configured to:
estimate a wait time associated with a first shower facility based on a number of people in a queue waiting for a shower and information gathered over a period of time with respect to use of the first shower facility, and
store the estimated wait time; and
at least one second device comprising:
a memory configured to:
store information associated with a plurality of sites that each include shower facilities, wherein each of the plurality of sites corresponds to a travel center or truck stop and the information includes location information and an estimated wait time at each of the shower facilities, and
logic configured to:
receive, from a mobile device, a request for information associated with reserving a shower,
access the memory or communicate with the at least one first device to obtain the estimated wait time at the first shower facility, and
forward the estimated wait time to the mobile device.

20. (canceled)

21. The system of claim 19, wherein the logic of the at least one second device is further configured to:
receive, from the mobile device, a request to reserve a shower at the first shower facility,
send, to the at least one first device, a first communication including information to reserve a shower at the first shower facility for a party associated with the mobile device, and
send, to the mobile device, a second communication including information indicating that a shower has been reserved for the party at the first shower facility.

22. The system of claim 21, wherein the at least one first device is further configured to:
reserve, for the party, a shower at the first shower facility, in response to the first communication.

23. The computer-readable medium of claim 1, further including instructions for causing the at least one processor to:
identify a direction in which the user is traveling, and when forwarding the first communication, the instructions cause the at least one processor to:
forward information identifying the direction of travel with the first communication, and
wherein the identified plurality of shower facilities are located within the predetermined distance of the geographical location obtained by the GPS unit in a forward direction with respect to the direction in which the user is traveling.

24. The computer-readable medium of claim 1, further including instructions for causing the at least one processor to:
receive, from the network device, information identifying at least some of the plurality of travel centers or truck stops, wherein each of the plurality of travel centers or truck stops is located within the predetermined distance of the geographical location associated with the user;
receive, from the user, a third input selecting a first one of the travel centers or truck stops;
forward a fourth communication identifying the first travel center or truck stop;
receive, from the network device, information identifying the number of available parking spaces at the first travel center or truck stop;
output, to a display, information identifying the number of available parking spaces at the first travel center or truck stop; and
forward a fifth communication to the first travel center or truck stop to reserve one of the available parking spaces at the first travel center or truck stop.

25. The computer-implemented method of claim 10, wherein the first communication includes information identifying a direction in which the user device is traveling, and
wherein identifying the at least two sites comprises identifying the at least two sites within the predetermined distance of the user device in a forward direction with respect to the direction in which the user device is traveling.

26. The system of claim 19, wherein when estimating a wait time, the at least one first device is configured to:
identify the number of people in the queue,
determine an average shower time,
determine an average time for cleaning a shower,
determine an average lag time between a time that a shower is available until a time that a customer enters the shower, and
calculating the estimated wait time based on the number of people in the queue, the average shower time, the average time for cleaning a shower and the average lag time.
